(19) United States
(12) Patent Application Publication
(10) Pub. No.: US 2006/0176369 A1
(43) Pub. Date: Aug. 10, 2006

(54) Portable, self-contained video recording and display system and method

(76) Inventor: Ronald R. Meritt, Arroyo Grande, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/348,921

(22) Filed: Feb. 6, 2006

Related U.S. Application Data
(60) Provisional application No. 60/649,999, filed on Feb. 4, 2005.

(51) Int. Cl. H04N 7/18; G08B 29/00; G08B 1/08; G08B 13/00; G08C 19/06

(52) U.S. Cl. 348/143; 340/870.31; 340/541; 340/506; 340/539.1

(57) ABSTRACT

A video surveillance system is described. The system includes a main unit and a mount. The main unit includes, a camera, a local data storage coupled to the camera, an interface and a control. The main unit is removably coupled to the mount. A method of capturing video data is also described.

### CROSS REFERENCE TO RELATED APPLICATIONS

This application claims priority from U.S. Provisional Patent Application No. 60/649,999 filed on Feb. 4, 2005 and entitled “Portable, Self-Contained Video Recording and Display System and Method,” which is incorporated herein by reference in its entirety.

### BACKGROUND OF THE INVENTION

The present invention relates generally to portable video recording, and more particularly, to methods and systems for portable video recording and surveillance.

Portable video recording systems are typically very cumbersome and complex and include multiple separate components. This unnecessary complexity leads to increased system cost, increased operating cost, reduced portability, reduced reliability and, in certain applications, are substantial barriers to optimum use of the portable video recording and surveillance system.

In view of the foregoing, there is a need for a simpler, more integrated and more portable video recording and surveillance system.

### SUMMARY OF THE INVENTION

Broadly speaking, the present invention fills these needs by providing a video surveillance system. It should be appreciated that the present invention can be implemented in numerous ways, including as a process, an apparatus, a system, computer readable media, or a device. Several inventive embodiments of the present invention are described below.

One embodiment provides a video surveillance system is described. The system includes a main unit and a mount. The main unit includes, a camera, a local data storage coupled to the camera, an interface and a control. The main unit is removably coupled to the mount.

At least a portion of the local data storage can be digital media is at least one of a group consisting of a digital memory, a DRAM, or a flash memory. Alternatively, at least a portion of the local data storage is digital media is at least one of a group consisting of a hard drive, a magnetic media, or a optical drive. At least a portion of the local data storage is removable from the main unit. The removable at least a portion of the local data storage can also include a security device. The security device can include a protective case. The security device can include an encryption device.

The video surveillance system can also include an external audio unit coupled to the main unit by a first data link. The first data link includes at least one of a first wired data link or a first wireless data link.

The main unit can also include an external power receptacle and the mount can couple an external electrical power source to the external power receptacle. The main unit can include an interface and wherein the interface includes a second wireless data link.

The video surveillance system can also include a central storage system. The central storage system can be coupled to the main unit via a third wireless data link. The central storage system includes a controller, a display, a data storage and a data archive. The main unit can include a first data encryption unit and the central data system can include a corresponding second data encryption unit.

The video surveillance system can also include one or more external cameras coupled to the main unit by a fourth data link. The fourth data link includes at least one of a second wired data link or a fourth wireless data link.

The mount can be is mounted in a vehicle. The camera can be capable of detecting at least one of a low-light image or an infrared image. The main unit can also include a protective case.

Another embodiment provides a method of capturing video data. The method includes activating a video surveillance system, detecting video data, wherein the camera detects the video data and storing the detected video data in the local data storage. The video surveillance system includes a main unit and a mount. The main unit includes a camera, a local data storage coupled to the camera, an interface, and a control. The main unit is removably coupled to the mount. The video data can also include audio data. At least a portion the audio data is received from an external microphone. The external microphone can be included in an external audio unit coupled to the main unit by a first data link. The first data link can include at least one of a first wired data link or a first wireless data link.

The method can also include archiving the stored video data from the local data storage in a central storage system. Archiving the stored video data from the local data storage in the central storage system can include establishing a data link between the main unit and the central storage system. The data link can include at least one of a wired data link and a wireless data link. The stored video data can be transferred from the local data storage to the central storage system over the data link.

The video data transferred to the central storage system over the data link can include video data that is detected in about real-time. The method can also include mounting the main unit in the mount and removing the main unit from the mount. Mounting the main unit in the mount can include coupling an external power source to the main unit. Removing the main unit from the mount can include disconnecting the electrical power source from the main unit.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1A is a block diagram of a portable, integrated video recording and surveillance system, in accordance with one embodiment of the present invention.

FIG. 1B is a block diagram of a USB dongle, in accordance with one embodiment of the present invention.

FIG. 2 is a block diagram of a video surveillance system, in accordance with one embodiment of the present invention.

FIG. 3 is a block diagram of an exemplary application of the video surveillance system, in accordance with one embodiment of the present invention.

FIG. 4 is a flowchart diagram that illustrates the method operations performed in installing and using the portable, integrated video recording and surveillance system, in accordance with one embodiment of the present invention.

FIG. 5 is a flowchart diagram that illustrates the method operations performed operating the portable, integrated video recording and surveillance system, in accordance with one embodiment of the present invention.

FIG. 6 is a flowchart diagram that illustrates the method operations performed archiving the stored video and/or audio and/or other data in the local data storage, in accordance with one embodiment of the present invention.

FIG. 7 is a flowchart diagram that illustrates an alternative method operations performed in archiving the stored video and/or audio and/or other data in the local data storage, in accordance with one embodiment of the present invention.

FIG. 8 is a flowchart diagram that illustrates the method operations performed in storing video and/or audio and/or other data in the central storage, in accordance with one embodiment of the present invention.

FIG. 9 shows a side view of a main unit in a mount, in accordance with one embodiment of the present invention.

FIG. 10 shows an end view of a main unit in a mount, in accordance with one embodiment of the present invention.

### DETAILED DESCRIPTION OF THE EXEMPLARY EMBODIMENTS

Several exemplary embodiments for an integrated, portable video recording and surveillance system and methods of using and operating such as system will now be described. It will be apparent to those skilled in the art that the present invention may be practiced without some or all of the specific details set forth herein. It should be appreciated that the present invention can be implemented in numerous ways, including as a process, an apparatus, a system, computer readable media, or a device. Several inventive embodiments of the present invention are described below.

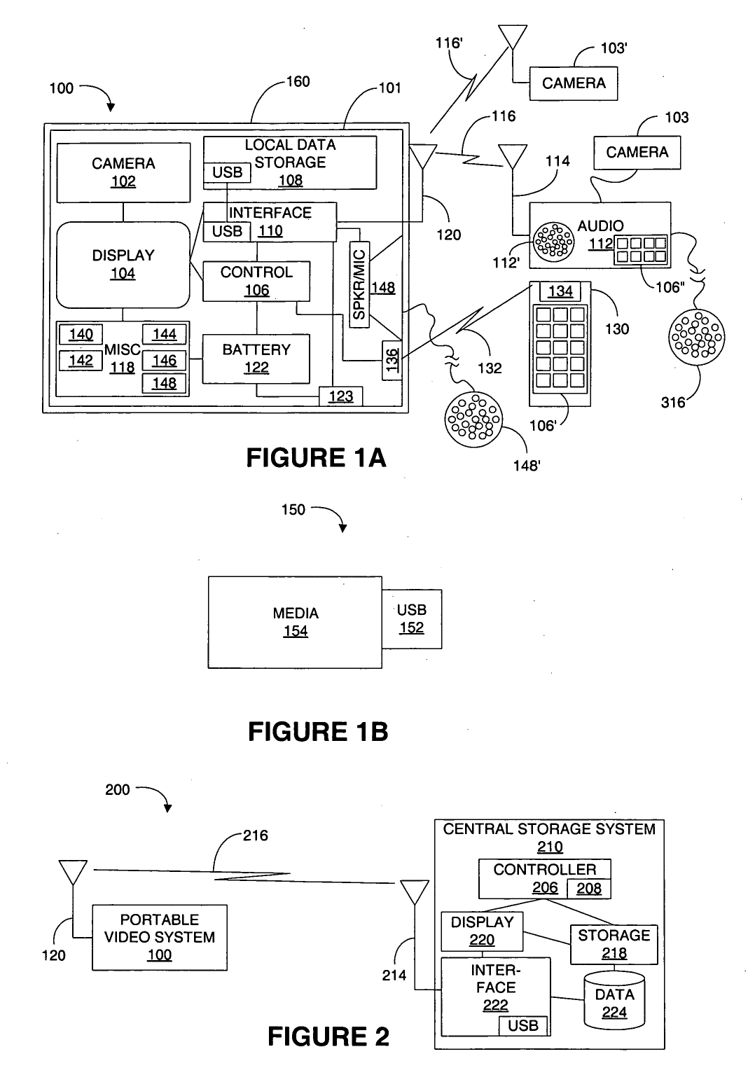

FIG. 1A is a block diagram of a portable, integrated video recording and surveillance system 100, in accordance with one embodiment of the present invention. The system 100 includes a main unit 101 and an optional external audio unit 112. The main unit 101 includes a camera 102, a display 104, a control panel 106, a local storage system 108, an interface 110 and a miscellaneous unit 118. The main unit 101 can also include a battery 122 to provide a portable power and battery back-up. The main unit 101 can also include a speaker 148. The speaker 148 can also include a microphone. An external speaker 148′ and/or microphone can be connected/disconnected from the main unit 101.

The main unit 101 can also include a protective case 160. The protective case 160 can be a metal case (e.g., aluminum, steel, magnesium, titanium, alloys thereof and similar metals and alloys) or other protective materials (e.g., high impact plastics, Kevlar, polycarbonate, etc.). The protective case 160 can provide protection from several shock and impacts (e.g., bullet-proofing, shock-proofing to multiple gravitational force impacts) and physical security (e.g., tamper resistance) to protect the main unit 101 from damage. The protective case 160 can also include electromagnetic shielding to shield the main unit 101 from external electromagnetic signals and interference.

The camera 102 captures video information. The camera 102 can include telephoto (i.e., zoom, wide-angle, narrow-angle), auto-focus and image stabilization functions. The camera 102 can also include a mechanical optical zoom and/or digital zoom functions. The camera 102 can be a CCD or other type of device capable of capturing electronic images. The camera 102 can also include infrared spectra and/or low light-type (i.e., less than about 5 lux ambient light) and/or light amplification imaging technology. The camera 102 can be color or black and white.

The camera 102 can include a digital recording capability and/or an analog recording capability. The camera 102 can also include a subsystem for video image compression (e.g., MPEG 3, MPEG 4, or other proprietary and industry standard video image compression algorithm). The camera 102 can also record at one or more frame rates. By way of example the camera 102 can record images at a frame rate within a range of between less than about 1 frame per second to about 50 or more frames per second. The camera 102 can also be used to capture still images. The camera 102 can also include anti-skip technology.

The camera 102 can also record a counter and/or timer or other data with the video/audio data. By way of example, the camera can record a time recorded (i.e., record time) or a time left to record (i.e., a count down on storage capacity remaining). Recorded time intervals can be within a range of about 1/100^{th} of a second or more. The camera 102 can also record location data, additional audio tracks, etc.

The camera 102 can also include more than one additional cameras. The additional cameras can be included within the main unit 101 or be external to the main unit 101. By way of example, the additional cameras may be directed out of two or more directions from the main unit 101. The additional cameras can also be external to the main unit 101 such as external cameras 103 and 103′. The additional cameras 103 and 103′ can be coupled to the main unit 101 via a wired or wireless data link 116′, 116. Data from each of the multiple cameras can be recorded within the main unit 101. By way of example, the video data from external camera 103′ and camera 102 can be stored as split screen data where video from both cameras 102 and 103′ are combined in a single screen. Alternatively, the video data from external camera 103′ and camera 102 can be stored as separate full screen recordings.

The camera 102, 103, 103′ can also have pre-programmed functions. By way of example a single hot-key can initiate one or more of the cameras 102, 103, 103′ to zoom in (or out) and record still images at various zoom settings. More specifically, during a traffic stop a police officer can select a preprogrammed hotkey and cause the camera 102 to zoom from maximum field of view (i.e., maximum wide angle) to maximum zoom (e.g., minimum angle). In this manner, the camera 102 can zoom in on a license plate of the vehicle in front of the police officer. As the camera 102 changes zoom angle from maximum to minimum, the camera can capture one or more still images (e.g., 2 or more), each of the still images at a different zoom angle.

The miscellaneous unit 118 can also include optical character recognition (OCR) software that can be used to recognize a license plate number or other text present in the camera's view. The miscellaneous unit 118 can also automatically report one or more of the still images and/or video images and/or other data and the recognized license plate number to the central storage system 210 as described in more detail below.

The display 104 is coupled to the camera 102 and can display the images captured by the camera. The display 104 can playback recorded images and even the current (i.e., real time) image. The display 104 can be a monochrome (e.g., black and white) although a color display is preferable. The display 104 can be a LCD, TFT or similar type of displays that are well known in the art.

The display 104 can also display time, date, location, a counter and other data available to the main unit 101. The display 104 can also display a status of various systems external to the main unit. By way of example, if the system 100 is installed in a police car, then the brake lights, emergency lights, siren, radar/laser gun, speedometer, collision indicator and other systems in the police vehicle could be coupled to the system 100 and displayed on the display.

The display 104 can also include the control panel 106. By way of example, the display 104 can include a touch screen and the control panel 106 can include soft keys that can be displayed and hidden (e.g., when not needed) on the display. Alternatively, the control panel 106 can be dedicated controls, separate from the display 104. In yet another alternative, the control panel 106 can be a combination of one or more soft keys on the display and one or more separate control buttons. The control panel 106 provides the user controls for controlling the portable, integrated video recording and surveillance system 100. By way of example, the control panel can include a power switch, a zoom control for the camera 102, one or more hotkeys described above, start and stop recording controls to allow the user to start and stop the storage of the images captured by the camera 102.

The control panel 106 can also include alphanumeric keys that can enter alphabetic data into the main unit 101. By way of example, one or more fields can be provided for user data such as a user name or identification number. Further, the control panel 106 can also be used to enter an encryption/decryption key. The control panel 106 can also include controls that can vary the brightness, contrast, color, etc. of the display 104 and the volume of the speaker 148.

An alternative control panel 106′ can also be included in a remote control 130. The remote control 130 can communicate with the portable, integrated video recording and surveillance system 100 via a data link 132. The data link 132 can be wireless, as shown, or wired. A wireless data link 132 can be RF or infrared or ultra-violet or any other type of wireless link. The remote control 130 includes transmitter/receiver 134 capable of communicating with the portable, integrated video recording and surveillance system 100. The transmitter/receiver 134 can communicate with the interface 110. Alternatively, the transmitter/receiver 134 can communicate with the portable, integrated video recording and surveillance system 100 via a dedicated receiver/transmitter 136. The alternative control panel 106′ can also be included in the audio unit 112.

At least one of the remote control 130 or the audio unit 112 can include one or more control buttons (e.g., record, audio, help, etc.) 106′, 106″. By way of example, pressing the record button causes the system 100 to begin recording audio and video. Pressing the record button again can stop recording. The record button may require multiple presses or a press and hold to ensure no inadvertent starting and stopping of the record function.

Pressing the audio button can toggle the remote microphone 316 on and off. The portable, integrated video recording and surveillance system 100 can record audio and/or video data from one or more audio and video sources simultaneously. The control buttons 106′, 106″ can also include a help or panic button. By way of example, pressing the help button can cause one or more of the cameras to automatically zoom to the widest field of view. The control buttons 106′, 106″ can also include indicators (e.g., LEDs) that indicate a current status of the system 100. By way of example, the indicator on the audio unit 112 can indicate that the system 100 is recording audio from the audio unit.

The interface 110 provides a connection to portions of the system 100 that are external to the main unit 101. By way of example, the interface 110 can provide a wired or wireless data link 116 to the audio unit 112. In an embodiment of providing a wireless data link 116, the main unit 101 can include a first antenna 120 and the audio unit 112 can include a second antenna 114. The interface 110 can support one or more various proprietary and industry standard protocols. By way of example the interface 110 can concurrently support one or more of a Bluetooth or IEEE 802.11 et seq. wireless link specifications.

Interface 110 can communicate with various other sources external from the main unit 101. By way of example, if the portable, integrated video recording and surveillance system 100 is used in a vehicle, the interface 110 can receive data inputs such as vehicle data (lights, siren, brakes, engine speed, etc.) collision detection (e.g., a g-force switch and/or air bag deployment) and radar/laser speed detection systems. These external sources can be coupled to the interface 110 through various wired or wireless connections. A preselected occurrence of a vehicle status can also be preprogrammed to cause the portable, integrated video recording and surveillance system 100 to take a desired action. By way of example, activating the emergency lights can cause the portable, integrated video recording and surveillance system to begin recording. Similarly, an air bag deployment can cause the portable, integrated video recording and surveillance system 100 to begin recording data.

The interface 110 can also provide an interface to the local data storage 108. The interface 110 can also include encryption technology to ensure the data integrity of the data stored on the local data storage 108. The interface 110 can also include encryption technology that prevents a user from accessing the local data storage 108.

The local data storage 108 can include data memory technology for storing the images captured by the camera 102, the audio captured by the microphone 112′ in the audio unit 112 and other selected data inputs. The data memory technology included in the local data storage 108 can include one or more of a flash memory, hard drives and other type of digital storage. By way of example, the local data storage 108 can include one or more hard drives (e.g., about 4 Gb to about 100 Gb, or larger hard drives). Similarly, the local data storage 108 can include one or more types of non-volatile memory. By way of example, the local data storage 108 can include combinations of hard drives, optical media drives and flash memory.

The local data storage 108 can include one or more removable media or non-removable media and combinations thereof. By way of example, the interface 110 can include one or more universal serial bus (USB) ports and the local data storage 108 include a USB dongle 150 that can connect to the one or more of the USB ports.

It should be understood that while a USB port is illustrated, any suitable interface could be used (e.g., PCI, PCMCIA, RS232, Ethernet, parallel, proprietary, SD memory card memory sticks, XD memory, Smart Media, or similar interfaces). Further, while a USB port, or similar interface, is shown as the connection between the interface 110 and the local data storage 108, it should be understood that the USB port, or similar interface can be used to interconnect each of the modules (e.g., 102, 104, 118, 108, 106, 148, 122, 123 and 140-148) included in the main unit 101. One or more of the modules 102, 104, 118, 108, 106, 148, 122, 123 and 140-148 included in the main unit 101 can be easily removable via the USB port, or similar interface such as for performance upgrade, customizability and repair.

FIG. 1B is a block diagram of a USB dongle 150, in accordance with one embodiment of the present invention. The USB dongle 150 includes an USB-compatible interface 152 and a media portion 154. The USB dongle 150 can then be connected and disconnected from the interface 110 as needed. Further, different capacity USB dongles can be used as the capacity of the local data storage 108 is varied. Further, a removable USB dongle 150 allows use of multiple USB dongles as the capacity of each dongle is consumed with stored data.

While a USB dongle 150 is described, the removable media used for at least a portion of the local data storage 108 is not limited to a USB dongle as other types of removable media can also be used (e.g., PCMCIA, Secure Digital (SD) memory card, compact flash, various types of memory sticks, XD memory, Smart Media and Multi Media to list but a few examples of commonly known types of removable media in addition to any suitable proprietary type of removable media). Further, the media portion 154 can include hard drives, flash memory, magnetic or optical media (e.g., writable compact disk, writable digital video disk) or any other type of data storage media. Further, the media portion 154 can include single write technology such as single write optical disk.

The media portion 154 can also include anti-tamper systems such as a protective case and/or edit protection hardware and software. By way of example, the media portion 154 can include a proprietary interface and/or encryption system to prevent access to the data stored therein except by an authorized person (e.g., the data recorded in the media portion 154 can be encrypted). The protective case can be a metal case (e.g., aluminum, steel, magnesium, titanium, alloys thereof and similar metals and alloys) or other protective materials similar to the protective case 160 described above. The media portion 154 can have a record capacity of up to about 8 hours or more (e.g. 12 hours, 16 hours, etc.). The removable media can also require a mechanical or electrical “key” or keycode to be removed from main unit 101. Such a key and keycode will help ensure the data integrity of the data stored on the removable media.

Referring again to FIG. 1A, the miscellaneous unit 118 can include various functional blocks. By way of example, the miscellaneous unit 118 can include a microprocessor 148 for controlling the main unit 101. The microprocessor 148 can include an operating system (e.g., Windows from Microsoft or Linux or other suitable operating systems) and software applications for controlling the operations of the portable, integrated video recording and surveillance system 100. An application can allow the microprocessor 148 to direct the main unit 101 to capture the various data inputs according to a preselected combination. By way of example, the application can specify that all audio and all GPS data are captured continuously while the video and remaining data are captured only after being initiated. The application can also specify various methods of initiating a data capture. By way of example, a manual selection by a user or an automatic initiation caused by a preselected triggering event.

The miscellaneous unit 118 can also include a global positioning system (GPS) receiver 140 so that the precise location, speed, direction, etc., of the portable, integrated video recording and surveillance system 100 can be determined. By way of example, the location of the system 100 can be captured and correlated with the captured video and audio. The miscellaneous unit 118 can also include a compass 142 that can identify a direction or orientation of the system 100.

The miscellaneous unit 118 can also include a unique device identifier (ID) 144 that identifies the system 100. The miscellaneous unit 118 can also include a system 146 to capture a unique user identifier (ID). The miscellaneous unit 118 can also include additional functionality such as detecting when a selected event has occurred (e.g., engine start stop, gear selection, brake activation, predetermined speed, siren/emergency lights activation/deactivation, air bag deployment, impact, etc.). The miscellaneous unit 118 allows other data, for example, the location, orientation, device ID and user ID to be captured with the captured audio and video. The miscellaneous unit 118 can also include a shock sensor to detect impacts to the main unit 101 and/or the vehicle the main unit may be mounted within.

The miscellaneous unit 118 can also control an auto power save to reduce power consumption by the system 100. By way of example, if no activity occurs within the vehicle that the system 100 is mounted in for a preselected time (e.g., about 60 minutes), then the miscellaneous unit 118 can automatically turn off the system 100. Alternatively, the miscellaneous unit 118 can place the system in a standby mode after a preselected time of inactivity. The preselected time can be adjustable. The miscellaneous unit can use one or more of various factors to determine if the activity has stopped. By way of example, the preselected time may start running from when the last button was pressed on the system 100. In the case of a GPS equipped system 100, the preselected time may start when the system has stopped moving. The miscellaneous unit 100 could also include a motion detector to determine if the system 100 is in motion or not.

The main unit 101 can also include an external power receptacle 123. The external power can supplant or assist the internal battery 122. The external power can be supplied within a range of about 9 VDC to about 19 VDC. The main unit 101 can also include can also include data input connections that are coupled to the interface 110 or other portions of the main unit. The data input connections can be included in the external power receptacle 123 or can be separate from the external power receptacle.

It should be understood that while the antennas 114 and 120 are shown as external elements, one or more of the antennas can be integrated within the respective units 112 and 101.

FIG. 2 is a block diagram of a video surveillance system 200, in accordance with one embodiment of the present invention. The video surveillance system 200 includes the portable, integrated video recording and surveillance system 100 and a central system 210. The central system 210 can include a controller 206, a central data storage/archive 218 and display system 220. The central system 210 can also include a corresponding communication interface 222 coupled to a third antenna 214. The central system 210 can also include databases 224 of information that can be provided to and stored from one or more portable, integrated video recording and surveillance systems 100. The central system 210 can also include encryption and/or security technology 208 that can ensure the data integrity of the data stored in the central data storage 218. By way of example, a key such as a digital signature can limit access to the central data storage 218. The key or digital signature can be included in a removable device such as a USB dongle. The same or if desired a different key can also be used to decrypt data stored in the portable, integrated video recording and surveillance system 100 and the central data storage 218.

The interface 110 can provide a wireless communication data link 216 (e.g., IEEE 802.11 et seq. standard specification or other wireless communication link) between the portable, integrated video recording and surveillance system 100 and the central system 210. In one embodiment, the interface 110 can provide a wireless data link 216 that can be used to transmit data from the portable, integrated video recording and surveillance system 100. Data that can be transmitted via the wireless data link 216 can include data stored in the local data storage 108 or images and audio data that are captured by the camera 102 and audio unit 112 in real time or near real time. Data that can be transmitted via the wireless data link 216 can also be encrypted to ensure security and integrity of the transmitted data.

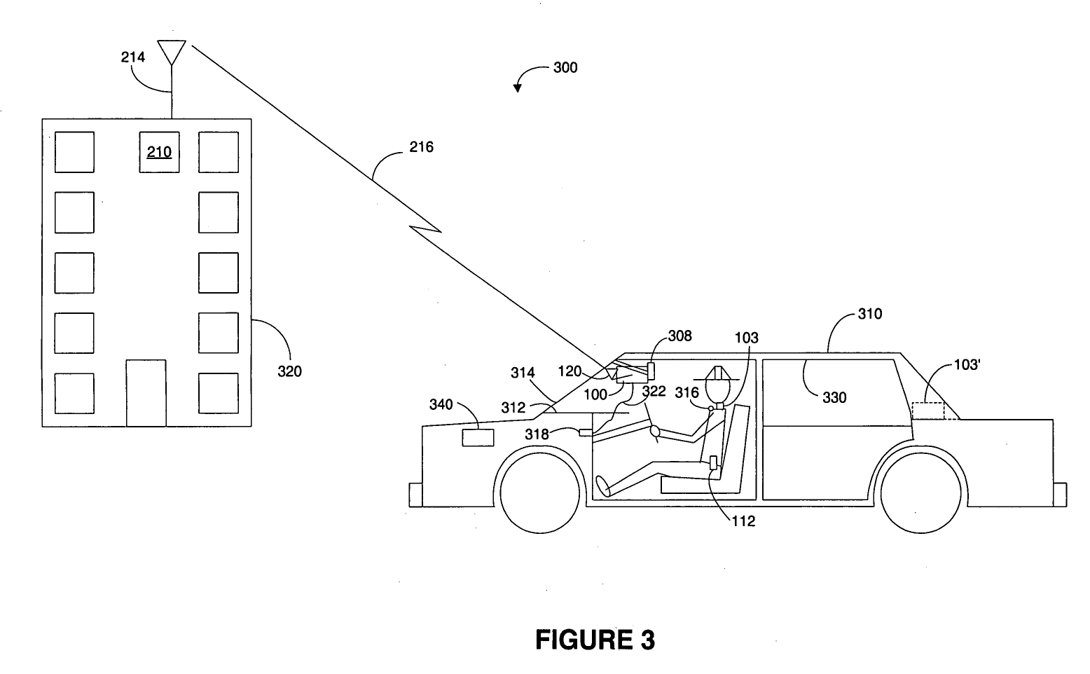

FIG. 3 is a block diagram 300 of an exemplary application of the video surveillance system 200, in accordance with one embodiment of the present invention. In this embodiment, the portable, integrated video recording and surveillance system 100 is mounted in a vehicle 310. The portable, integrated video recording and surveillance system 100 can be mounted on the dash 312 as shown. Alternatively, the portable, integrated video recording and surveillance system 100 can be mounted to or integrated into the rearview mirror 308 or to the ceiling 330 or roof of the vehicle 310. By way of example, the portable, integrated video recording and surveillance system 100 can be mounted to the mirror mount 308. The display 104 can be retractable (e.g., behind the mirror 308). Alternatively, the display 104 can be integrated into and visible through the surface of the mirror 308.

Additional, external cameras 103 and 103′ can be included in the system 100. One additional, external camera 103 can be mounted on a user with the audio unit 112. One or more additional external camera 103′ can be mounted on within the vehicle such as on a rear dash on in the rear window.

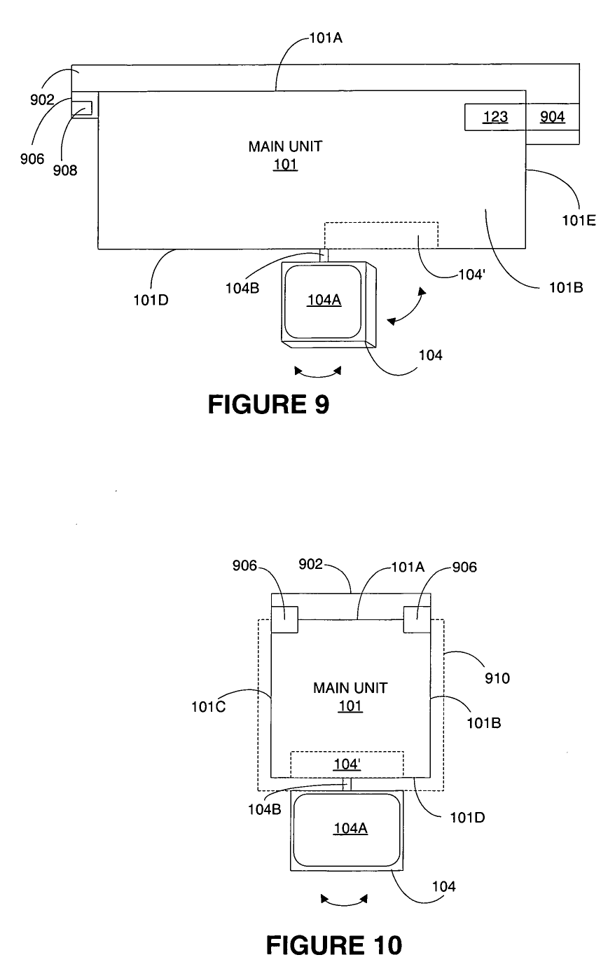

The portable, integrated video recording and surveillance system 100 can also be mounted in a mount that provides quick installation and removal from the vehicle 310. By way of example, the mount 902, as described in more detail in FIG. 9 below, can be attached to the dash 312 or the ceiling 330 of the vehicle 310.

The central system 210 can be located in a second location such as a building 320 or a second vehicle (not shown). A driver (e.g., a police officer or a security officer) can wear the audio unit 112 on his belt and a wired or wireless microphone 316 on or near his lapel or collar.

The data links 116, 116′, 132, 216 can be between about 2 MHz to about 10 GHz or any other suitable frequency band (HF, VHF, UHF, Microwave, laser, cellular telephone network, receiver/transmitter repeater systems, etc.). The data links 116, 132, 216 can also use more than one channel as are commonly known in the art (e.g., IEEE 802.11 et seq.). Data links 116, 116′ can have a range of up to about 1000 meters or more. The range of each of the data links 116, 116′, 132, 216 can also be selectable. Data link 216 can have a virtually unlimited range based on the technology used. By way of example, data link 216 can be limited to line of sight or near line of sight if directly supported between central storage system 210 and the main unit 101. Alternatively, the data link 216 range can be extended well beyond line of sight if the data link 216 is supported by a separate infrastructure such as receiver/transmitter repeater systems or cellular telephone networks, etc.

A vehicle data interface 340 can collect various vehicle data inputs from the vehicle 310. By way of example the vehicle data interface 340 can collect vehicle speed, gear selection, brake status, emergency lights/siren status, air bag deployment, engine on/off, and any other vehicle data value. The vehicle data interface 340 can couple the various vehicle data inputs to the portable, integrated video recording and surveillance system 100 via a wired or wireless data link (e.g., any one or more of data links 116, 116′ and 132). A wired data link can be connected to the portable, integrated video recording and surveillance system 100 through a dedicated electrical connector or a multipurpose electrical connector such as electrical connector 123. The wired data link can be connected to the portable, integrated video recording and surveillance system 100 through the connector 904 and 123 through the mount 902. The vehicle data interface 340 can also be included in the main unit 101.

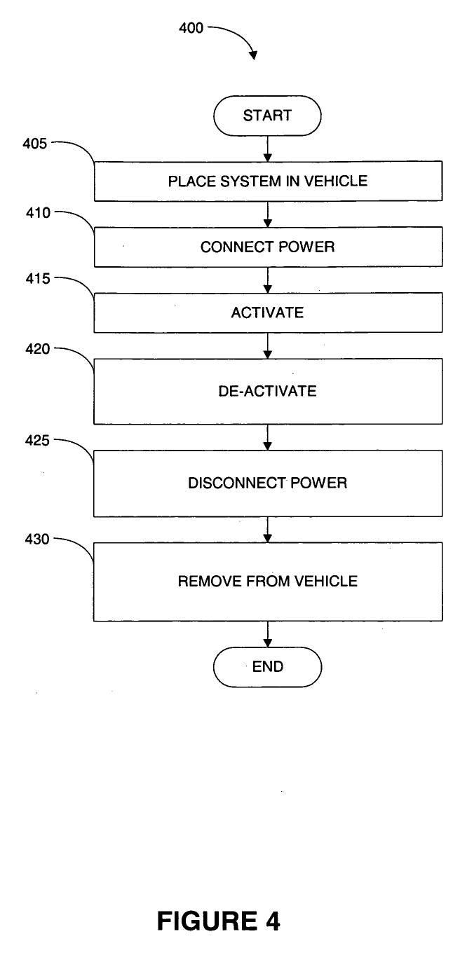

FIG. 4 is a flowchart diagram that illustrates the method operations 400 performed in installing and using the portable, integrated video recording and surveillance system 100, in accordance with one embodiment of the present invention. In an operation 405, the portable, integrated video recording and surveillance system 100 is placed in a vehicle 310 such as on the dash 312. The portable, integrated video recording and surveillance system 100 can be secured to the vehicle 310 such as by straps (e.g., Velcro, buckles, etc.) or suction cups (e.g., suction cups to the dash 312 and/or the windshield 314) or other easily removable mounting systems.

In an optional operation 410, if an external power source is needed, the external power source 318 can be connected to the portable, integrated video recording and surveillance system 100. By way of example, a power cord 322 can connect the portable, integrated video recording and surveillance system 100 to a cigarette lighter 318 or similar electrical power outlet in the vehicle 310.

Placing the portable, integrated video recording and surveillance system 100 in the vehicle 310 as described in operation 405 above and the connecting power as described in operation 410 can be accomplished in a single operation such as mounting the portable, integrated video recording and surveillance system 100 in a mount. Placing the portable, integrated video recording and surveillance system 100 in the vehicle 310 as described in operation 405 above and the connecting power as described in operation 410 can also include coupling the vehicle data interface 340 to the portable, integrated video recording and surveillance system.

In an operation 415, the portable, integrated video recording and surveillance system 100 is activated. Activating the system 100 can include turning on the power and capturing video and/or audio data and other data. In an operation 420, the portable, integrated video recording and surveillance system 100 is de-activated (e.g., powered-off).

The portable, integrated video recording and surveillance system 100 can be easily removed from the vehicle 310 in operations 425 and 430. In operation 425, if the system 100 is connected to an external power source 318 in optional operation 410 above, then the external power source is disconnected. In operation 430 the portable, integrated video recording and surveillance system 100 can be removed from the vehicle 310.

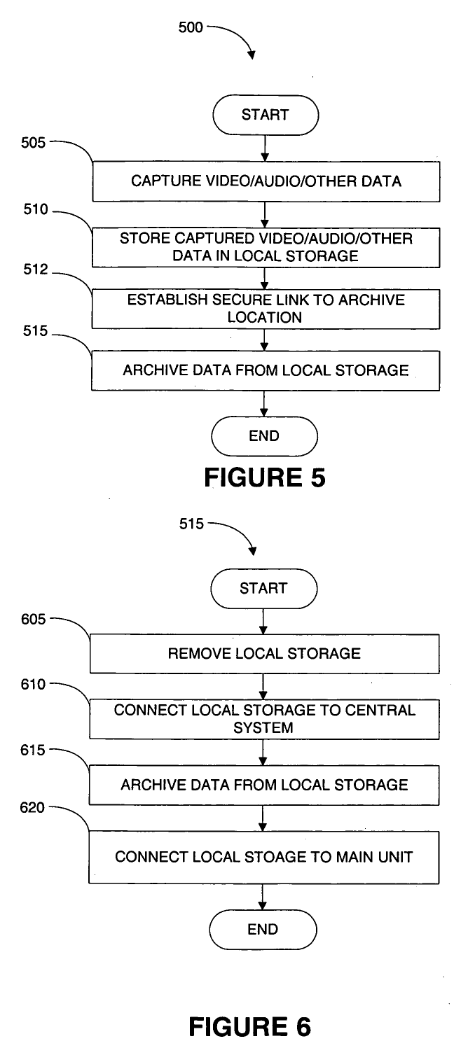

FIG. 5 is a flowchart diagram that illustrates the method operations 500 performed operating the portable, integrated video recording and surveillance system 100, in accordance with one embodiment of the present invention. In an operation 505, the portable, integrated video recording and surveillance system 100 captures video and/or audio and/or other data. A user can determine what the system 100 captures via the control panel 106.

In one embodiment, the portable, integrated video recording and surveillance system 100 can be capturing video and audio information continuously and then automatically overwriting a preselected time interval. By way of example, the portable, integrated video recording and surveillance system 100 can capture 90 seconds of video and audio data. On the 91^{st} second, the first second is overwritten with the 91^{st} second data. Similarly, the 92 second data overwrites the 2^{nd} second of data and so forth. Therefore, the portable, integrated video recording and surveillance system 100 can capture a rolling 90 second of video and audio data. When a triggering event occurs (e.g., a preselected event occurs or a user initiates a capture), the rolling 90 seconds of data can be automatically appended to the newly acquired video and audio data. More specifically, if on the 91^{st} second, the user initiates a capture, then the first 90 seconds of data is preserved and 91^{st} second of data is recorded without overwriting the first 90 seconds of data. It should be understood that a rolling 90 seconds of data is exemplary only and the rolling data capture can be more or less than 90 seconds (e.g., 30 seconds, 15 minutes, etc.).

This continuous rolling data capture is referred to as pre-event recording. Pre-event recording can be a valuable asset as preliminary events that lead up to a triggering event can be captured. The preliminary events can provide useful data to better understand the events that caused the triggering event and the events that occurred after the triggering event.

In an operation 510, the captured video and/or audio and/or other data can be stored in the local data storage 108. The captured video and/or audio and/or other data can be stored in the local data storage 108 in near real time.

In an operation 512, a secure data connection is established between the local storage and the archive location (e.g., the central system 210). Establishing the secure data connection can require keys for access to the local storage and the archive location and/or encryption/decryption of the data being transferred to the archive location.

In an operation 515, the stored video and/or audio and/or other data in the local data storage 108 can be archived. The stored video and/or audio and/or other data in the local data storage 108 can be archived in any of several methods. By way of example, the video and/or audio and/or other data can be downloaded to the central system 210. Alternatively, a removable portion of the local data storage 108 can be removed and replaced. The removed portion of the local data storage 108 can then be downloaded into the central system 210. Alternatively, the removed portion of the local data storage 108 can be archived as hardware.

FIG. 6 is a flowchart diagram that illustrates the method operations 515 performed archiving the stored video and/or audio and/or other data in the local data storage 108, in accordance with one embodiment of the present invention. In an operation 605, the storage 108 can be removed from the main unit 101. By way of example, if the local data storage 108 includes a removable USB dongle, then the USB dongle can be disconnected or removed from the main unit 101.

In an operation 610, the removable storage 108 is connected to the central storage 218 in the central system 210. By way of example, if the local data storage 108 includes a removable USB dongle, then the USB dongle can be connected to the central storage 218.

In an operation 615, the stored video and/or audio and/or other data in the local data storage 108 can be transferred from the local data storage 108 and archived (i.e., stored) in the central storage 218 in the central system 210. By way of example, the stored video and/or audio and/or other data removable in the USB dongle 150 can be transferred to the central storage 218. Transferring the stored video and/or audio and/or other data in the local data storage 108 also typically includes removing the stored video and/or audio and/or other data in the local storage. In an operation 620, the removable storage 108 is reconnected to the main unit 101.

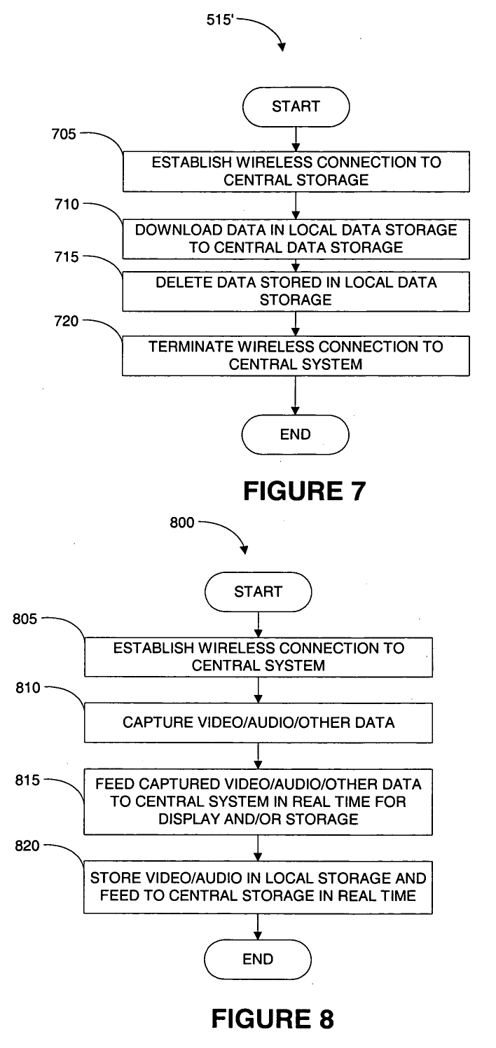

FIG. 7 is a flowchart diagram that illustrates an alternative method operations 515′ performed in archiving the stored video and/or audio and/or other data in the local data storage 108, in accordance with one embodiment of the present invention. In an operation 705, a wired or wireless connection can be established between the portable, integrated video recording and surveillance system 100 and the central system 210. In one embodiment, the interface 110 in the main unit 101 can be electrically coupled by a cable (e.g., USB, Ethernet, video, twisted pair, etc.) to the central system 210. Alternatively, the interface 110 can establish a wireless data link 216 to the central system 210.

In the instance of the interface 110 establishing a wireless data link 216 to the central system 210, the wireless data link can be established manually or automatically. By way of example, the wireless data link 216 can be established at a preselected time. Alternatively, the wireless data link 216 can be established when the portable, integrated video recording and surveillance system 100 reaches a preselected location. Specifically, the location can be determined by the received GPS coordinates or when the portable, integrated video recording and surveillance system 100 is within a certain range of the central system 210. The wireless data link 216 can also be maintained as a constant data link.

In an operation 710, the stored video and/or audio and/or other data in the local data storage 108 can be transferred from the local storage and archived (i.e., stored) in the central storage 218 in the central system 210. If the wireless data link 216 is maintained as a constant data link, then the central system 210 can initiate the transfer of the stored video and/or audio and/or other data in the local data storage 108. In an optional operation 715, the video and/or audio and/or other data stored in the local data storage 108 can be deleted. In an operation 720, the wireless data link 216 can be terminated once the data transfer is completed.

FIG. 8 is a flowchart diagram that illustrates the method operations 800 performed in storing video and/or audio and/or other data in the central storage 218, in accordance with one embodiment of the present invention. In an operation 805, a wireless data link 218 can be established between the portable, integrated video recording and surveillance system 100 and the central system 210.

In an operation 810, the video and/or audio and/or other data captured by the main unit 101 of the portable, integrated video recording and surveillance system 100 is transmitted to the central system 210 via the wireless data link 218.

In an optional operation 815, the transmitted video and/or audio and/or other data can be displayed and/or stored in the central system 210. In an optional operation 815, the video and/or audio and/or other data captured by the main unit 101 can be stored in the local data storage 108. A key can be required to access the data stored in the central system 210. By way of example, the central system 210 can be secured and require a key or keycode to access the stored data. Similarly, the stored data may be encrypted and a keycode may be required to decrypt the stored data so that the stored data can be accessed. The keycode or a different keycode may be required to edit or modify the stored data.

The present invention provides an easy to install, simple to operate, compact, integrated video recording and surveillance system that can be used in any number of applications. Other aspects and advantages of the invention will become apparent from the following detailed description, taken in conjunction with the accompanying drawings, illustrating by way of example the principles of the invention.

It should be understood that while Ethernet, Bluetooth and various IEEE 802.11 et seq. standards are referenced, these are merely exemplary embodiments and the invention should not be limited to utilizing these electronic communication protocols as any suitable electronic communication protocol or combinations of such protocols could be used.

FIG. 9 shows a side view of a main unit 101 in a mount 902, in accordance with one embodiment of the present invention. The mount 902 securely holds the main unit 101. The mount 902 includes one or more latches 906 that hold the main unit 101 in the mount. The one or more of the latches 906 can also include a lock 908 to secure the main unit 101 in the mount 902. The lock 908 can be an electronic lock or a typical mechanical key-type lock such as are well known in the art.

The mount 902 can be securely and permanently attached to a desired location. By way of example, the mount 902 can be attached to or inside a dash 312 or a ceiling 330 in a vehicle. The mount 902 can also be attached to the vehicle in other locations such as under the seat. The mount 902 provides a quick and easy installation of the main unit 101. The mount 902 can be formed from metal or plastic or any other suitable material.

The mount 902 can include one or more connectors 904 that establish secure electrical connections to a corresponding receptacle (e.g., electrical power receptacle 123) on the main unit. Additional electrical connections can also be established through the mount. By way of example, external camera 103′ or other external data sources can be connected to the main unit 101 through an electrical connector in the mount 902. Electrical power and/or other electrical connections from the vehicle 310 can be connected from the vehicle 310 to the mount. The mount 902 can include electrical connectors that couple the electrical connections to between the portable, integrated video recording and surveillance system 100 and the vehicle 310.

FIG. 10 shows an end view of a main unit 101 in a mount 902, in accordance with one embodiment of the present invention. While the mount 902 is shown as securing the main unit 101 substantially by a single side 101A of the main unit 101, it should be understood that the mount 902 could fully or partially encompass one or more additional sides of the main unit. By way of example, the mount 902 could include a cover 910 that substantially covers one or more additional sides 101B-D. The cover 910 can more fully secure the main unit 101 in the mount 902. The cover 910 can also provide additional protection for the main unit 101. By way of example the cover 910 can supplement or replace the protective case 160 described above in FIG. 1A. The cover 910 can be manufactured from a metallic material (e.g., aluminum, steel, magnesium, titanium, alloys thereof and similar metals and alloys) or other protective materials (e.g., high impact plastics, Kevlar, polycarbonate, etc.).

Referring to FIGS. 9 and 10 above, the display 104 can have a fixed position on the main unit 101 or as shown in FIGS. 9 and 10, the display can be rotated up to about 360 degrees for ease of viewing about a pivot 104B. The pivot 104B can also allow the display 104 to be stowed in a protected location 104′ within the main unit 101. In the protected location 104′ the display screen portion 104A of the display 104 can be rotated toward the main unit 101 and therefore protected from damage as may be desired during transport of the main unit. Alternatively, the display screen portion 104A of the display 104 can be rotated to face outward from the main unit 101 so that the display screen portion is visible and can be used to display video and/or data.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data that can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the embodiments described herein and attached the claims.

What is claimed is:

1. A video surveillance system comprising:
a main unit including:
a camera;
a local data storage coupled to the camera;
an interface; and
a control; and
a mount, wherein the main unit is removably coupled to the mount.

2. The video surveillance system of claim 1, wherein at least a portion of the local data storage is digital media is at least one of a group consisting of a digital memory, a DRAM, or a flash memory.

3. The video surveillance system of claim 1, wherein at least a portion of the local data storage is digital media is at least one of a group consisting of a hard drive, a magnetic media, or a optical drive.

4. The video surveillance system of claim 1, wherein at least a portion of the local data storage is removable from the main unit.

5. The video surveillance system of claim 4, wherein the removable at least a portion of the local data storage includes a security device.

6. The video surveillance system of claim 5, wherein the security device includes a protective case.

7. The video surveillance system of claim 5, wherein the security device includes an encryption device.

8. The video surveillance system of claim 1, further comprising an external audio unit coupled to the main unit by a first data link, wherein the first data link includes at least one of a first wired data link or a first wireless data link.

9. The video surveillance system of claim 1, wherein the main unit further includes an external power receptacle and the mount couples an external electrical power source to the external power receptacle.

10. The video surveillance system of claim 1, wherein the main unit includes an interface and wherein the interface includes a second wireless data link.

11. The video surveillance system of claim 1, further comprising a central storage system.

12. The video surveillance system of claim 11, wherein the central storage system is coupled to the main unit via a third wireless data link.

13. The video surveillance system of claim 11, wherein the central storage system includes:
a controller;
a display;
a data storage; and
a data archive.

14. The video surveillance system of claim 13, wherein the main unit includes a first data encryption unit and the central data system includes a corresponding second data encryption unit.

15. The video surveillance system of claim 1, further comprising one or more external cameras coupled to the main unit by a fourth data link, wherein the fourth data link includes at least one of a second wired data link or a fourth wireless data link.

16. The video surveillance system of claim 1, wherein the mount is mounted in a vehicle.

17. The video surveillance system of claim 1, wherein the camera is capable of detecting at least one of a low-light image or an infrared image.

18. The video surveillance system of claim 1, wherein the main unit includes a protective case.

19. A method of capturing video data comprising:
activating a video surveillance system, the video surveillance system includes:
a main unit including:
a camera;
a local data storage coupled to the camera;
an interface; and
a control; and
a mount, wherein the main unit is removably coupled to the mount; and
detecting video data, wherein the camera detects the video data; and
storing the detected video data in the local data storage.

20. The method of claim 19, wherein the video data includes audio data.

21. The method of claim 20, wherein at least a portion the audio data is received from an external microphone.

22. The method of claim 21, wherein the external microphone is included in an external audio unit coupled to the main unit by a first data link, wherein the first data link includes at least one of a first wired data link or a first wireless data link.

23. The method of claim 19, further comprising archiving the stored video data from the local data storage in a central storage system.

24. The method of claim 23, wherein archiving the stored video data from the local data storage in the central storage system includes:
establishing a data link between the main unit and the central storage system, wherein the data link includes at least one of a wired data link and a wireless data link; and
transferring the stored video data from the local data storage to the central storage system over the data link.

25. The method of claim 24, wherein the video data transferred to the central storage system over the data link includes video data that is detected in about real-time.

26. The method of claim 19, further comprising:
mounting the main unit in the mount; and
removing the main unit from the mount.

27. The method of claim 26, wherein mounting the main unit in the mount includes coupling an external power source to the main unit and wherein removing the main unit from the mount includes disconnecting the electrical power source from the main unit.
